(19) United States
(12) Patent Application Publication
(10) Pub. No.: US 2026/0131816 A1
(43) Pub. Date: May 14, 2026

(54) DRIVING ASSISTANCE APPARATUS, DRIVING ASSISTANCE METHOD, DRIVING ASSISTANCE PROGRAM, AND STORAGE MEDIUM

(71) Applicants: DENSO CORPORATION, Kariya-city (JP); TOYOTA JIDOSHA KABUSHIKI KAISHA, Toyota-shi (JP); J-QuAD DYNAMICS Inc., Tokyo (JP)

(72) Inventors: Naotsugu SHIMIZU, Tokyo (JP); Seiya FUJITSU, Tokyo (JP)

(21) Appl. No.: 19/380,588

(22) Filed: Nov. 5, 2025

(30) Foreign Application Priority Data
Nov. 8, 2024 (JP) 2024-195926

(51) Int. Cl. B60W 50/14; B60W 30/18

(52) U.S. Cl. CPC B60W 50/14; B60W 30/18159; B60W 2050/143; B60W 2050/146; B60W 2520/06; B60W 2554/4044; B60W 2554/802

(57) ABSTRACT

A driving assistance apparatus includes a travel trajectory acquisition unit, an own vehicle direction acquisition unit, a target travelling direction acquisition unit, and a notification subject determination unit. The travel trajectory acquisition unit acquires a travel trajectory of an own vehicle. The own vehicle direction acquisition unit acquires an own vehicle direction that is a direction in which the own vehicle is facing on the travel trajectory. The target travelling direction acquisition unit acquires a target travelling direction that is a travelling direction of another vehicle serving as the object present behind the own vehicle. The notification subject determination unit determines whether the other vehicle is a notification subject based on the own vehicle direction and the target travelling direction.

### CROSS-REFERENCE TO RELATED APPLICATIONS

This application is based on and claims the benefit of priority from Japanese Patent Application No. 2024-195926, filed on Nov. 8, 2024. The entire disclosure of the above application is incorporated herein by reference.

### BACKGROUND

The present disclosure relates to a driving assistance apparatus, a driving assistance method, a driving assistance program, and a non-transitory computer-readable storage medium.

A driving assistance apparatus that detects an object to a rear side of an own vehicle and prompts a driver to use caution is known. The driving assistance apparatus recognizes that the own vehicle is turning at an intersection and narrows, in a direction approaching the own vehicle, either of a rear left-side detection range and a rear right-side detection range that is on an outer side of a turning direction of the own vehicle.

### SUMMARY

An aspect of the present disclosure provides a driving assistance apparatus that is configured to, based on detection information of an object in a vicinity of an own vehicle, notify an occupant of the own vehicle that the own vehicle and the object are approaching each other. The driving assistance apparatus acquires a travel trajectory of the own vehicle, acquires an own vehicle direction that is a direction in which the own vehicle is facing on the travel trajectory, and acquires a target travelling direction that is a travelling direction of another vehicle serving as the object present behind the own vehicle. The driving assistance apparatus determines whether the other vehicle is a notification subject based on the own vehicle direction and the target travelling direction.

### BRIEF DESCRIPTION OF THE DRAWINGS

In the accompanying drawings:

FIG. 1 is a schematic diagram illustrating a state in which another vehicle is approaching, from a rear right side, a vehicle to which the present disclosure is applied;

FIG. 2 is a schematic diagram illustrating a state in which the vehicle shown in FIG. 1 is turning left;

FIG. 3 is a block diagram illustrating an overall apparatus configuration of an in-vehicle system shown in FIG. 1 and FIG. 2;

FIG. 4 is a block diagram illustrating an overall functional configuration actualized by a driving assistance apparatus shown in FIG. 3;

FIG. 5 is a conceptual diagram illustrating an operational overview of the driving assistance apparatus shown in FIG. 4;

FIG. 6 is a conceptual diagram illustrating an example of a method for determining a closest point shown in FIG. 5;

FIG. 7 is a flowchart illustrating an overview of an operational example of the driving assistance apparatus shown in FIG. 3;

FIG. 8 is a flowchart illustrating an overview of an operational example of the driving assistance apparatus shown in FIG. 3; and

FIG. 9 is a flowchart illustrating an overview of an operational example of the driving assistance apparatus shown in FIG. 3.

### DESCRIPTION OF THE EMBODIMENTS

Embodiments of the present disclosure relate to a driving assistance apparatus that is configured to, based on detection information of an object in a vicinity of a vehicle, notify an occupant that the vehicle is approaching the object, a driving assistance method, a driving assistance program, and a computer-readable, non-transient, tangible storage medium on which the driving assistance program is recorded.

A driving assistance apparatus that detects an object to a rear side of an own vehicle and prompts a driver to use caution is known (refer to, for example, JP 2012-243069 A). The driving assistance apparatus described in JP 2012-243069 A includes an intersection recognizing unit and a detection range changing unit. The intersection recognizing unit recognizes that the own vehicle is turning at an intersection. When the intersection recognizing unit recognizes that the own vehicle is turning at an intersection, the detection range changing unit narrows, in a direction approaching the own vehicle, either of a rear left-side detection range and a rear right-side detection range that is on an outer side of a turning direction of the own vehicle.

Therefore, while the own vehicle is turning at an intersection and the driver is assumed to not have an intention of advancing the own vehicle towards the outer side of the turning direction, the detection range on the outer side of the turning direction of the own vehicle is narrowed in the direction approaching the own vehicle, compared to when the own vehicle is not turning at an intersection. As a result, another vehicle advancing straight ahead on the outer side of the turning direction of the own vehicle is not easily detected. Consequently, notification that is unnecessary and bothersome to the driver can be suppressed.

In the driving assistance apparatus described in JP 2012-243069 A, for example, when the own vehicle completes turning, the detection range that has been narrowed in the direction approaching the own vehicle is restored to a state before narrowing. At this time, depending on a positional relationship between the own vehicle and another vehicle that is a following vehicle, before the own vehicle turns and is advancing straight ahead without turning, an unnecessary notification may be issued as a result of the other vehicle entering the detection range.

It is thus desired to provide a technology that, for example, enables unnecessary notification regarding detection of another vehicle present on a rear side of the own vehicle to be more appropriately suppressed.

A first exemplary embodiment of the present disclosure provides a driving assistance apparatus that is configured to, based on detection information of an object in a vicinity of an own vehicle, notify an occupant of the own vehicle that the own vehicle and the object are approaching each other, the driving assistance apparatus includes: a travel trajectory acquisition unit that acquires a travel trajectory of the own vehicle; an own vehicle direction acquisition unit that acquires an own vehicle direction that is a direction in which the own vehicle is facing on the travel trajectory; a target travelling direction acquisition unit that acquires a target travelling direction that is a travelling direction of another vehicle serving as the object present behind the own vehicle; and a notification subject determination unit that determines whether the other vehicle is a notification subject based on the own vehicle direction and the target travelling direction.

A second exemplary embodiment of the present disclosure provides a driving assistance method by which, based on detection information of an object in a vicinity of an own vehicle, an occupant of the own vehicle is notified that the own vehicle and the object are approaching each other, the driving assistance method including the following steps or processes: acquiring a travel trajectory of the own vehicle; acquiring an own vehicle direction that is a direction in which the own vehicle is facing on the travel trajectory; acquiring a target travelling direction that is a travelling direction of another vehicle serving as the object present behind the own vehicle; and determining whether the other vehicle is a notification subject based on the own vehicle direction and the target travelling direction.

A third exemplary embodiment of the present disclosure provides a driving assistance program executed by a driving assistance apparatus that is configured to, based on detection information of an object in a vicinity of an own vehicle, notify an occupant of the own vehicle that the own vehicle and the object are approaching each other. The driving assistance program includes processes performed by the driving assistance apparatus, the processes including: a process for acquiring a travel trajectory of the own vehicle; a process for acquiring an own vehicle direction that is a direction in which the own vehicle is facing on the travel trajectory; a process for acquiring a target travelling direction that is a travelling direction of another vehicle serving as the object present behind the own vehicle; and a process for determining whether the other vehicle is a notification subject based on the own vehicle direction and the target travelling direction.

A fourth exemplary embodiment of the present disclosure provides a non-transitory computer-readable storage medium storing therein a driving assistance program executed by a driving assistance apparatus that is configured to, based on detection information of an object in a vicinity of an own vehicle, notify an occupant of the own vehicle that the own vehicle and the object are approaching each other. The driving assistance program includes processes performed by the driving assistance apparatus, the processes including: a process for acquiring a travel trajectory of the own vehicle; a process for acquiring an own vehicle direction that is a direction in which the own vehicle is facing on the travel trajectory; a process for acquiring a target travelling direction that is a travelling direction of another vehicle serving as the object present behind the own vehicle; and a process for determining whether the other vehicle is a notification subject based on the own vehicle direction and the target travelling direction.

Here, elements may be given reference numbers in parentheses in each section of the application documents. However, the reference numbers merely indicate examples of corresponding relationships between the elements and specific means described according to the embodiments described hereafter. Therefore, the present disclosure is not limited in any way by the reference numbers described above.

### EMBODIMENTS

Exemplary embodiments or specific examples of the present disclosure will hereinafter be described with reference to the drawings as appropriate. Here, the embodiment and modifications thereof, as well as descriptions in related drawings below are schematic or simplified to concisely explain the contents of the present disclosure, and are not intended to limit the contents of the present disclosure in any way. Therefore, it goes without saying that the descriptions in the drawings do not necessarily match specific apparatus configurations that are actually manufactured and sold. In other words, it goes without saying that the present disclosure should not be interpreted in a limited manner by the descriptions in the drawings, and the corresponding descriptions of apparatus configurations and functions or operations thereof, described below, unless explicitly limited by the applicant through the prosecution history of the present application.

### In-Vehicle System Configuration

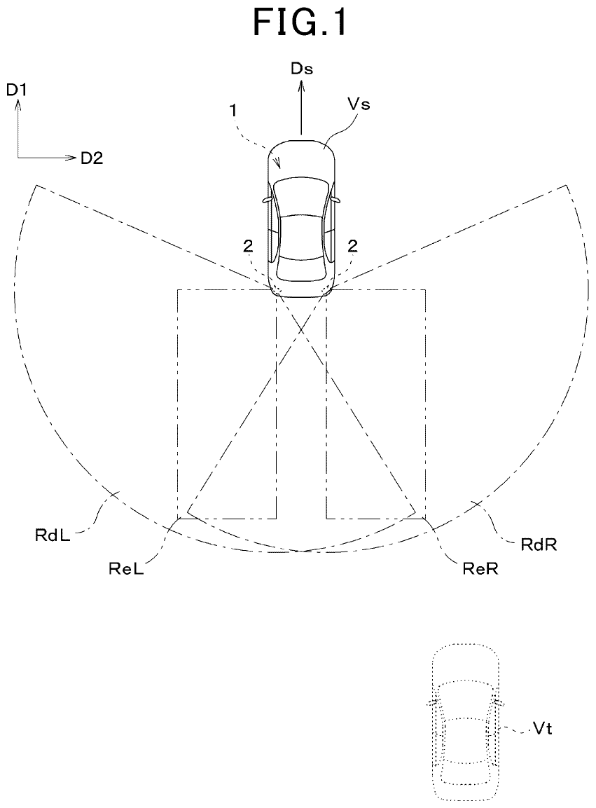

First, with reference to FIG. 1, an in-vehicle system 1 is mounted in a vehicle and is thereby configured to perform various operations of the vehicle. The vehicle in which the in-vehicle system 1 according to the present embodiment is mounted is referred to, hereafter, as an own vehicle Vs. The own vehicle Vs is a so-called standard automobile capable of traveling on a road and has a box-shaped body. In FIG. 1, a vehicle longitudinal direction D1 is a direction defining an overall length of a vehicle body of the own vehicle Vs and is a direction perpendicular to a vehicle width direction D2. The vehicle longitudinal direction D1 is parallel to a travelling direction while the own vehicle Vs is traveling straight ahead and an own vehicle direction Ds that is a direction in which the own vehicle Vs is facing. The travelling direction while the own vehicle Vs is traveling straight ahead and the own vehicle direction Ds coincide.

The in-vehicle system 1 is configured to perform various operations of the own vehicle Vs, including a warning operation, based on detection results for objects in the vicinity of the own vehicle Vs detected using the object detection sensor 2. For example, the object detection sensor 2 a radar sensor. According to the present embodiment, a pair of object detection sensors 2 that are radar sensors are provided on left and right sides in a rear end portion of the vehicle body of the own vehicle Vs. In addition, the in-vehicle system 1 is configured to notify an occupant of the vehicle Vs, such as the driver, that the own vehicle Vs and an object are approaching each other based on the detection information of an object on a rear side of the own vehicle Vs detected by the object detection sensor 2.

Specifically, the in-vehicle system 1 is configured to set a rear left notification area ReL within a rear left detection area RdL, and a rear right notification area ReR within a rear right detection area RdR. Here, the rear left notification area ReL and the rear right notification area ReR may be collectively referred to as simply “notification areas.”

The rear left detection area RdL is a detection range of the object detection sensor 2 mounted on a rear left end portion of the vehicle body of the own vehicle Vs. The rear right detection area RdR is a detection range of the object detection sensor 2 mounted on a rear right end portion of the vehicle body of the own vehicle Vs. The rear left notification area ReL is a virtual rectangular area that extends from a mounting position of the object detection sensor 2 to the rear left side of the vehicle Vs within the rear left detection area RdL, and is parallel to the vehicle longitudinal direction D1 and the vehicle width direction D2. The rear right notification area ReR is a virtual rectangular area that extends from the mounting position of the object detection sensor 2 to the rear right side of the vehicle Vs within the rear right detection area RdR, and is parallel to the vehicle longitudinal direction D1 and vehicle width direction D2.

When another vehicle Vt is detected within the notification area, the in-vehicle system 1 is configured to issue a notification that the other vehicle Vt is approaching the own vehicle Vs from the rear side. Here, the other vehicle Vt may be a two-wheeled vehicle such as a motorcycle, in addition to an automobile. The term “notification” can also be rephrased as “warning.”

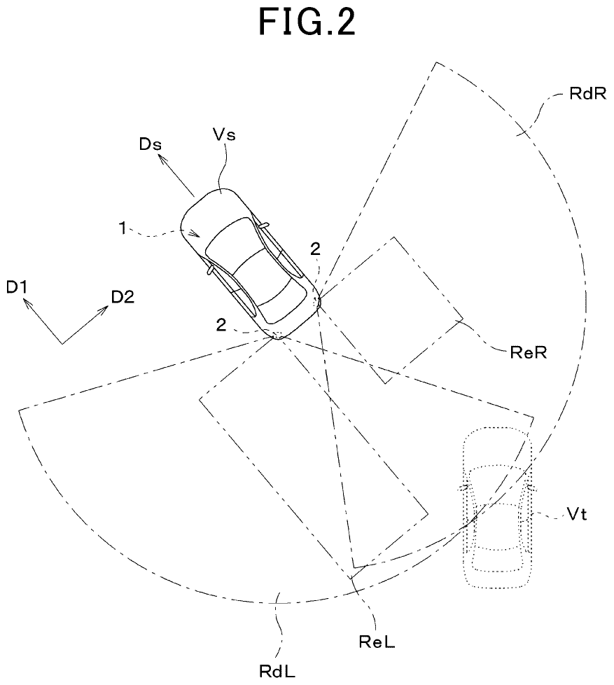

In addition, as shown in FIG. 2, the in-vehicle system 1 is configured to reduce the notification area in at least the vehicle longitudinal direction D1 such that an outer edge approaches the own vehicle Vs, based on a turning direction while the own vehicle Vs is turning. FIG. 2 shows a state in which the rear right notification area ReR that is on the outer side is reduced in the vehicle longitudinal direction D1 while the own vehicle Vs is turning left.

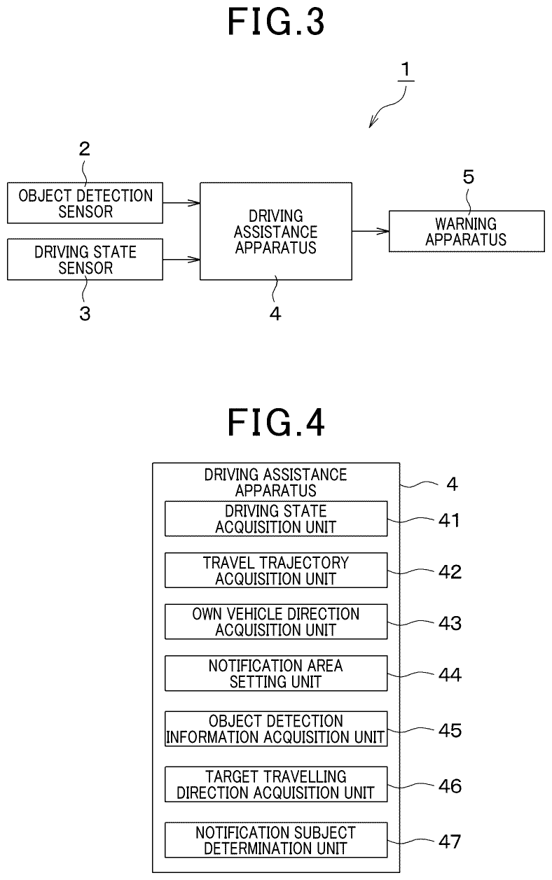

With reference to FIG. 3, the in-vehicle system 1 includes, in addition to the object detection sensor 2, a driving state sensor 3, a driving assistance apparatus 4, and a warning apparatus 5. The object detection sensor 2 and the driving state sensor 3 are connected to the driving assistance apparatus 4 by an in-vehicle network such that output from the object detection sensor 2 and the driving state sensor 3 is input to the driving assistance apparatus 4. In addition, the driving assistance apparatus 4 and the warning apparatus 5 are connected by the in-vehicle network to be capable of exchanging information or signals.

The driving state sensor 3 is provided to detect various quantities related to a driving state of the own vehicle Vs. The “driving state” includes a driving operation state and a driving behavior state of the own vehicle Vs. The “driving operation state” refers to a state of driving operation input for the own vehicle Vs performed by the occupant (that is, typically the driver) of the own vehicle Vs or a driving control electronic control unit (ECU). For example, the driving operation state includes an accelerator opening, an amount of brake operation, an amount of steering, a shift range, and the like. The “driving behavior state” refers to a state related to movement or behavior of the own vehicle Vs. For example, the driving behavior state includes a vehicle speed, acceleration, a yaw rate, and the like. That is, the vehicle state sensor 2 is a collective term for well-known in-vehicle sensors, such as a pedal operation amount sensor, a steering amount sensor, a vehicle speed sensor, and a yaw rate sensor. Furthermore, the driving state sensor 3 may also include a locator for acquiring positional information of the own vehicle Vs.

The driving assistance apparatus 4 is a so-called driving assistance ECU, and is configured to control driving assistance operations including a warning operation by the warning apparatus 5, based on the output from the object detection sensor 2 and the driving state sensor 3. The warning apparatus 5 includes an audio output device that generates a warning sound, a visual output device that displays a warning or emits a warning light, and the like. As a visual output device for giving notification that the other vehicle Vt is approaching from the rear side, for example, a head-up display apparatus or a light-emitting apparatus provided on a side mirror may be used. That is, the driving assistance apparatus 4 is configured to notify the occupant of the own vehicle Vs that the own vehicle Vs and an object such as the other vehicle Vt are approaching each other, based on the detection information of the object in the vicinity of the own vehicle Vs. The other vehicle Vt that is a subject of the notification is referred to as a “notification subject.”

According to the present embodiment, the driving assistance apparatus 4 is configured as an in-vehicle microcomputer including a processor such as a central processing unit (CPU) and a memory such as a read-only memory (ROM). The memory is a computer-readable, non-transitory, tangible storage medium, and includes a random access memory (RAM) and a non-volatile memory. The non-volatile memory includes at least a ROM, but may also include a non-volatile rewritable memory. The non-volatile rewritable memory is a storage apparatus that allows information to be rewritten while power is turned on but retains information in a non-rewritable manner while power is interrupted. For example, the non-volatile rewritable memory is a flash memory. The non-volatile memory stores therein a computer program, as well as various types of data such as initial values, maps, and look-up tables required to run the computer program

### Driving Assistance Apparatus

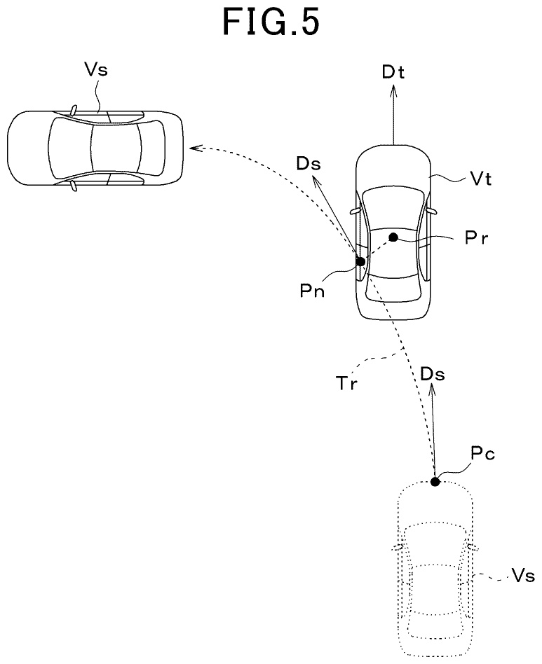

In this way, the driving assistance apparatus 4 is configured to be capable of performing driving assistance operations by the processor reading and running the computer program from the non-volatile memory. FIG. 4 shows an example of a functional block configuration actualized by the processor provided in the driving assistance apparatus 4 reading and running a driving assistance program that is a computer program, from the nonvolatile memory.

As shown in FIG. 4, the driving assistance apparatus 4 has the following as a functional configuration actualized by running the computer program. That is, the functional configuration includes a driving state acquisition unit 41, a travel trajectory acquisition unit 42, a vehicle direction acquisition unit 43, a notification area setting unit 44, an object detection information acquisition unit 45, a target travelling direction acquisition unit 46, and a notification subject determination unit 47. These units will be successively described below.

The driving state acquisition unit 41 acquires the driving state of the own vehicle Vs based on the output of the driving state sensor 3. The driving state includes physical quantities related to driving behavior of the own vehicle Vs, such as the vehicle speed and the yaw rate, as well as driving operation quantities such as the steering amount. In addition, the driving state may also include the positional information of the own vehicle Vs acquired by a locator and the like.

As shown in FIG. 5, the travel trajectory acquisition unit 42 acquires a travel trajectory Tr of the own vehicle Vs. The travel trajectory Tr is a movement trajectory of a predetermined point on the own vehicle Vs. For example, the predetermined point is a front end point on the vehicle body of the own vehicle Vs, or a center point of a planar view shape of the vehicle body. The “planar view shape” refers to an external shape of the vehicle at an attitude allowing the vehicle to travel on a horizontal plane (that is, an attitude at which all wheels are in full contact with the horizontal plane), in which the vehicle body of the vehicle is viewed vertically downward from above or the vehicle body is projected onto the horizontal plane.

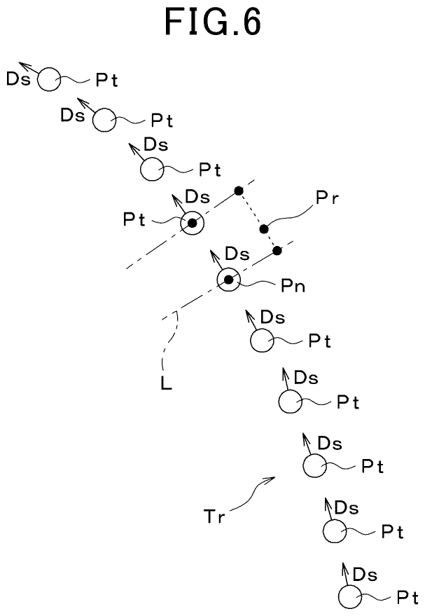

The travel trajectory Tr can be acquired (that is, calculated or estimated) based on the driving state of the own vehicle Vs acquired by the driving state acquisition unit 41. More specifically, as shown in FIG. 6, the travel trajectory Tr can be acquired as a time-series collection of a plurality of trajectory points Pt including the position of the own vehicle Vs discretely arranged for every predetermined amount of time, and information on the own vehicle direction Ds at each trajectory point Pt. The calculation or estimation of the travel trajectory Tr is already publicly known or well-known at the time of filing of the present application. Therefore, further detailed descriptions will be omitted in the present specification.

The own vehicle direction acquisition unit 43 acquires the own vehicle direction Ds that is the direction in which the own vehicle Vs is facing on the travel trajectory Tr. As shown in FIG. 5, the own vehicle direction Ds on the travel trajectory Tr is a tangential direction at a specific point of interest on the travel trajectory Tr. In other words, as shown in FIG. 6, the own vehicle direction Ds on the travel trajectory Tr is the own vehicle direction Ds stored in correspondence with a specific trajectory point Pt among the plurality of trajectory points Pt composing the travel trajectory Tr.

According to the present embodiment, as shown in FIG. 5, the own vehicle direction acquisition unit 43 acquires the own vehicle directions Ds at a turning start point Pc and a closest point Pn. The own vehicle direction Ds at the closest point Pn corresponds to “an own vehicle first direction.” The own vehicle direction Ds at the turning start point Pc corresponds to “an own vehicle second direction.”

The turning start point Pc is a point on the travel trajectory Tr corresponding to a position at which turning behavior of the own vehicle Vs starts. For example, the turning start point Pc can be defined as a point at which a radius of curvature of the travel trajectory Tr becomes less than a predetermined turning start determination threshold (such as 100 m). The closest point Pn is a point on the travel trajectory Tr closest to a reference point Pr on the other vehicle Vt. The reference point Pr is a center point of the other vehicle Vt, that is, a center point of a planar view shape of the vehicle body.

Specifically, the closest point Pn can be prescribed by a method shown in FIG. 6. The reference point Pr in FIG. 6 is the center point of the other vehicle Vt at a current time, that is, at a time when at least one specific process for determining whether the other vehicle Vt is a notification subject or a routine including this process is performed. First, at each of two or three points that are close to the reference point Pr among the plurality of trajectory points Pt, a virtual straight line L that is perpendicular to the vehicle direction Ds at each point is formed. Then, the trajectory point Pt corresponding to the virtual straight line L that is closest to the reference point Pr, among the plurality of virtual straight lines L, can be set as the closest point Pn.

The notification area setting unit 44 sets a notification area based on the driving state of the own vehicle Vs acquired by the driving state acquisition unit 41. Specifically, the notification area setting unit 44 sets a shape of the notification area in a non-contracted state as shown in FIG. 1 while the own vehicle Vs is traveling straight ahead, and in a contracted state as shown in FIG. 2 while the own vehicle Vs is turning. Whether the own vehicle Vs is traveling straight ahead or turning can be determined based on the steering amount and/or the radius of curvature of the travel trajectory Tr. A threshold used in the determination based on the radius of curvature of the travel trajectory Tr may be the same as the turning start determination threshold or may differ.

The object detection information acquisition unit 45 acquires the detection information of an object in the vicinity of the own vehicle Vs using the object detection sensor 2. The detection information includes presence/absence of an object, a moving direction, and a moving speed. The target travelling direction acquisition unit 46 acquires a target travelling direction Dt that is a travelling direction of the other vehicle Vt that is present behind or to the rear side of the own vehicle Vs

When the other vehicle Vt is detected within the notification area, the notification subject determination unit 47 determines whether the other vehicle Vt is a notification subject based on the own vehicle direction Ds and the target travelling direction Dt. Specifically, the notification subject determination unit 47 excludes the other vehicle Vt from the notification subject should a predetermined exclusion condition be met. Meanwhile, the notification subject determination unit 47 sets the other vehicle Vt as the notification subject should the exclusion condition not be met.

The exclusion condition typically includes a condition for excluding, from the notification subject, the other vehicle Vt that is traveling behind or to the rear side of the own vehicle Vs before the own vehicle Vs turns left or right at an intersection and that continues to travel straight ahead after the own vehicle Vs turns left or right at the intersection. That is, the exclusion condition includes at least one of the following first direction condition and second direction condition.
First direction condition: an angle formed by the own vehicle direction Ds (that is, the own vehicle first direction) and the target travelling direction Dt at the closest point Pn is equal to or greater than a predetermined first threshold.
Second direction condition: an angle formed by the own vehicle direction Ds (that is, the own vehicle second direction) and the target travelling direction Dt at the turning start point Pc is equal to or less than a predetermined second threshold.

According to the present embodiment, when both the first direction condition and the second direction condition, described above, are met and when both a time condition and a distance condition, described below, are met, the other vehicle Vt is excluded from the notification subject. Here, the time condition is that the shape of the rear left notification area ReL or the rear right notification area ReR has been restored from the contracted state such as that shown in FIG. 2 to a normal state such as that shown in FIG. 1.
Time condition: the current time is within a predetermined amount of time after the turning behavior of the own vehicle Vs has ended.
Distance condition: the other vehicle Vt is within a predetermined distance range behind the own vehicle Vs.

### Operational Overview

An overview of operations by an apparatus configuration according to the present embodiment (that is, the driving assistance apparatus 4) will be described below, in addition to effects achieved by the apparatus configuration, and methods and programs executed thereby. Here, in the description below, the apparatus configuration according to the present embodiment and the methods and programs executed thereby may be collectively referred to as “the present embodiment.”

The object detection sensor 2 detects objects behind and to the rear side of the own vehicle Vs. The driving state sensor 3 detects the driving state of the own vehicle Vs. Based on the object detection information from the object detection sensor 2 and the detection result for the driving state of the vehicle Vs from the driving state sensor 3, the driving assistance apparatus 4 notifies the occupant of the own vehicle Vs of the presence of another vehicle Vt approaching the own vehicle Vs from the rear side of the own vehicle Vs through the warning apparatus 5.

Here, for example, in a case in which the other vehicle Vt that is a following vehicle traveling straight ahead is present when the own vehicle Vs makes a left turn, the other vehicle Vt is not required to be a notification subject. Therefore, unnecessary and bothersome notification can be suppressed by the other vehicle Vt being excluded from the notification subject. Thus, according to the present embodiment, as shown in FIG. 2, a contraction process is performed on the rear right notification area ReR while the own vehicle Vs is turning left. As a result, the other vehicle Vt entering the rear right notification area ReR and becoming a notification subject can be favorably suppressed.

However, for example, a case can be considered in which, immediately after the own vehicle Vs enters a state of traveling straight ahead after completing the left turn and the contraction of the notification area is canceled, the other vehicle Vt such as that described above enters a portion expanded from the contracted state and becomes a notification subject. The other vehicle Vt is preferably excluded from the notification subject in such cases as well.

Therefore, according to the present embodiment, when the above-described first direction condition, second direction condition, time condition, and distance condition are met, the other vehicle Vt is excluded from the notification subject. The first direction condition is for determining that a difference between the own vehicle direction Ds during turning and an orientation of the other vehicle Vt is large, and the travelling direction of the other vehicle Vt is not along the travel trajectory Tr of the own vehicle Vs. The second direction condition is for inferring that a difference between the travelling direction of the own vehicle Vs at the turning start point and the travelling direction of the other vehicle Vt is small and the other vehicle Vt is a vehicle advancing straight ahead. The time condition takes into consideration a measure against unnecessary notification immediately after the contraction of the notification area is canceled. The distance condition is intended to limit a subject range to a rear end portion within the notification area after the contraction is canceled.

According to the present embodiment, the other vehicle Vt entering the portion expanded from the contracted state and becoming a notification subject immediately after the own vehicle Vs enters a state of traveling straight ahead after completing the left turn and the contraction of the notification area is canceled, can be favorably suppressed. Therefore, according to the present embodiment, unnecessary notifications can be more appropriately suppressed.

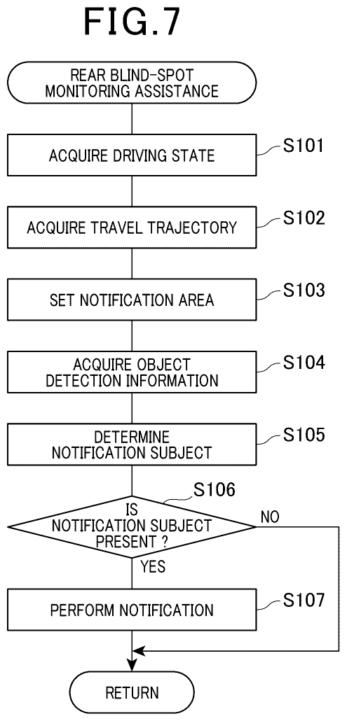

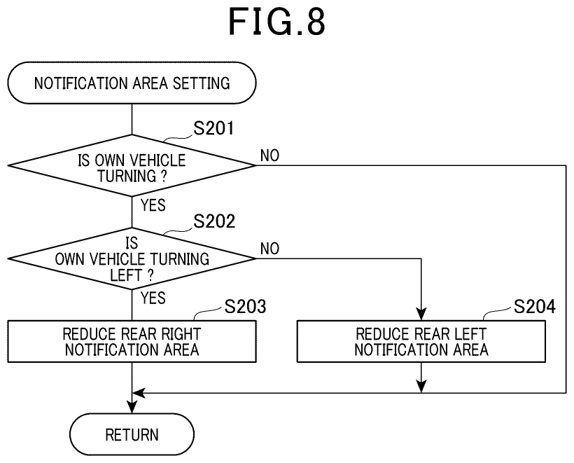

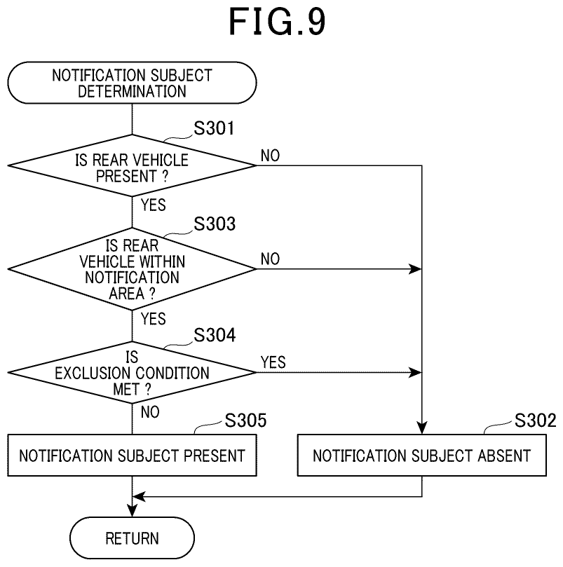

FIG. 7 is a flowchart of a routine corresponding to the driving assistance program according to the present embodiment, that is, a rear blind-spot monitoring assistance program. In the flowchart, “S” is an abbreviation of “step.” This similarly applies to FIG. 8 and FIG. 9. The processor and the non-volatile memory provided in the driving assistance apparatus 4 will be simply referred to hereafter as the “processor” and the “non-volatile memory”.

The processor reads out the rear blind-spot monitoring assistance program according to the present embodiment from the non-volatile memory and starts the program at predetermined time intervals (such as 10 msec). The processor thereby performs the driving assistance method according to the present embodiment. When the program is started, first, the processor performs processes at step S101 to step S106 in this order.

At step S101, the processor acquires the driving state of the own vehicle Vs. At step S102, the processor acquires, that is, calculates, the travel trajectory Tr of the own vehicle Vs. At step S103, the processor performs a notification area setting process based on the driving state acquired at step S101. That is, the processor sets the shapes of the rear left notification area ReL and the rear right notification area ReR.

FIG. 8 is a flowchart of details of the notification area setting process at step S103. First, at step S201, the processor determines whether the own vehicle Vs is turning. When determined that the own vehicle Vs is not turning (that is, NO at step S201), the processor skips all processes at step S202 and subsequent steps, and temporarily ends the notification area setting processing. In this case, the contraction process is not performed on the rear left notification area ReL and the rear right notification area ReR.

Meanwhile, when determined that the own vehicle Vs is turning (that is, YES at step S201), the processor proceeds to step S202. At step S202, the processor determines whether the own vehicle Vs is turning left.

When determined that the own vehicle Vs is turning left (that is, YES at step S202), the processor performs a process at step S203 and then temporarily ends the notification area setting process. At step S203, the processor performs the contraction process on the rear right notification area ReR. That is, the processor reduces the rear right notification area ReR at least in the vehicle longitudinal direction D1.

Meanwhile, when determined that the own vehicle Vs is turning right (that is, NO at step S202), the processor performs a process at step S204 and then temporarily ends the notification area setting process. At step S204, the processor performs the contraction process on the rear left notification area ReL. That is, the processor reduces the rear left notification area ReL at least in the vehicle longitudinal direction D1.

With reference again to FIG. 7, at step S104, the processor acquires the detection information of objects behind and to the rear side of the own vehicle Vs. At step S105, the processor performs a determination process regarding whether a notification subject is present within the notification area.

FIG. 9 is a flowchart of details of a notification subject determination process at step S105. First, at step S301, the processor determines whether a rear vehicle that is another vehicle Vt is present behind or to the rear side of the own vehicle Vs. When determined that a rear vehicle is not present (that is, NO at step S301), the processor performs a process at step S302 and then temporarily ends the notification subject determination process. At step S302, the processor determines that a notification subject is not present. Specifically, for example, the processor sets a notification subject presence flag to 0.

When determined that a rear vehicle is present (that is, YES at step S301), the processor proceeds to step S303. At step S303, the processor determines whether the rear vehicle is within the notification area, that is, the rear left notification area ReL or the rear right notification area ReR.

When determined that the rear vehicle is outside the notification area (that is, NO at step S303), the processor performs the process at step S302 and then temporarily ends the notification subject determination process. At step S302, the processor determines that a notification subject is not present.

When determined that the rear vehicle is within the notification area (that is, YES at step S303), the processor proceeds to step S304. At step S304, the processor determines whether the exclusion condition is met.

When determined that the exclusion condition is met (that is, YES at step S304), the processor performs the process at step S302 and then temporarily ends the notification subject determination process. At step S302, the processor determines that a notification subject is not present.

Meanwhile, when determined that the exclusion condition is not met (that is, NO at step S303), the processor performs a process at step S305 and then temporarily ends the notification subject determination process. At step s305, the processor determines that the notification subject is present. Specifically, for example, the processor sets the notification subject presence flag to 1.

With reference again to FIG. 7, at step S106, the processor determines whether the notification subject is present. Specifically, for example, the processor checks the state of the notification subject presence flag. When determined that the notification subject is present (that is, YES at step S106), the processor performs a process at step S107 and then temporarily ends the present routine. At step S107, the processor performs a notification process. Meanwhile, when determined that the notification subject is not present (that is, NO at step S106), the processor skips the process at step S302 and temporarily ends the present routine.

### Modifications

The present disclosure is not limited to the embodiment and specific examples described above. Therefore, the above-described embodiment and the like can be modified as appropriate. Representative modifications will be described below. In the description of modifications below, differences from the above-described embodiment and the like will be mainly described. In addition, sections that are identical or equivalent to each other among the above-described embodiments and the like, and the modifications described below are given the same reference numbers. Therefore, in the description of the modifications below, the description according to the above-described embodiments and the like are applicable as appropriate regarding constituent elements having the same reference numbers as those according to the above-described embodiments and the like, unless technical conflicts arise or additional descriptions are particularly given.

The present disclosure is not limited to the specific applications and apparatus configurations described according to the above-described embodiment. For example, the own vehicle Vs may be a so-called standard automobile or a large-sized automobile. That is, the shape and size of the vehicle body is not particularly limited.

The driving assistance apparatus 4 may be an object detection ECU or the driving control ECU. All or part of the driving assistance apparatus 4 may be configured to include a digital circuit, such as an ASIC or FPGA, configured to be capable of actualizing the functions or operations described above. ASIC is an abbreviation of Application Specific Integrated Circuit. FPGA is an abbreviation of Field Programmable Gate Array. That is, in the driving assistance apparatus 4, an in-vehicle microcomputer portion and a digital circuit portion can both be present.

A computer program of the present disclosure that enables the various operations, procedures, or processes described according to the above-described embodiment to be performed can be downloaded or upgraded through V2X communication using the communication apparatus 6. V2X stands for vehicle-to-X. Alternatively, the computer program can be downloaded or upgraded through a terminal apparatus provided at a manufacturing plant, a repair shop, a dealer, or the like, of the own vehicle Vs. The non-volatile rewritable memory to which the computer program is stored is not limited to a semiconductor memory such as a flash memory, and may be optical or magnetic storage media or the like.

In this manner, the functional configurations and processes described above may be actualized by a dedicated computer that is provided such as to be configured by the processor and the memory, the processor being programmed to provide one or more functions that are realized by a computer program. Alternatively, the functional configurations and processes described above may be actualized by a dedicated computer that is provided by the processor being configured by one or more dedicated hardware logic circuits. As another alternative, the functional configurations and processes described above may be actualized by one or more dedicated computers. The dedicated computer may be configured by a combination of one or more processors that are programmed to provide one or a plurality of functions, one or more memories, and one or more processors that are configured by one of more hardware logic circuits. In addition, the computer program may be stored in a non-transitory, tangible storage medium that can be read by a computer as instructions performed by the computer. That is, the functional configurations and processes described above can also be expressed as a computer program including steps to actualize the functional configurations and processes described above, or a non-transitory, tangible storage medium storing the computer program therein.

The present disclosure is not limited to the specific functions and operational examples described according to the above-described embodiment. For example, the exclusion condition is not limited to a logical AND of the first direction condition, the second direction condition, the time condition, and the distance condition. That is, for example, the exclusion condition may include only either of the first direction condition and the second direction condition. Alternatively, either or both of the time condition and the distance condition may be omitted. Specifically, for example, unnecessary notifications can be favorably suppressed during turning and during passage through a Y-intersection as a result of the time condition being omitted.

The manner in which the shape of the notification area changes from that before turning, that is, while traveling straight ahead to that during the turn can be modified as appropriate. That is, for example, the shape of the rear left notification area ReL and the rear right notification area ReR during a turn may be set to a partially annular shape conforming to a curvature of the turn. In addition, during a left turn, the rear right notification area ReR may not be set or may disappear instead of being contracted, that is, reduced in size.

It goes without saying that an element that configures the above-described embodiment is not necessarily a requisite unless particularly specified as being a requisite, clearly considered a requisite in principle, or the like. In addition, in cases in which a numeric value, such as quantity, numeric value, amount, or range, of a constituent element is mentioned, the present disclosure is not limited to the specific number unless particularly specified as being a requisite, clearly limited to the specific number in principle, or the like. In a similar manner, in cases in which a shape, direction, positional relationship, or the like of a constituent element or the like is mentioned, the present disclosure is not limited to the shape, direction, positional relationship, or the like unless particularly specified as being a requisite, clearly limited to the specific shape, direction, positional relationship, or the like in principle, or the like.

Similar expressions such as “acquire,” “calculate,” “estimate,” “detect,” and “sense” are interchangeable as long as technical conflicts do not occur. In addition, “exceeds a threshold” and “equal to or greater than a threshold” are interchangeable as long as technical conflicts do not occur. This similarly applies to “below a threshold” and “equal to or less than a threshold.”

Modifications are also not limited to the examples given above. For example, one of the plurality of modifications may be combined, in its entirety or in part, with another in its entirety or in part as long as technical conflicts do not occur. Moreover, the above-described specific example may be combined, in its entirety or in part, with an above-described modification in its entirety or in part as long as technical conflicts do not occur.

### Other Aspects

Characteristics of the present disclosure are as follows:

### Aspect 1

A driving assistance apparatus (4) that is configured to, based on detection information of an object in a vicinity of an own vehicle (Vs), notify an occupant of the own vehicle that the own vehicle and the object are approaching each other, the driving assistance apparatus including: at least one of (i) a circuit and (ii) a processor with a memory storing computer program code executable by the processor, the at least one of the circuit and the processor configured to implement: a travel trajectory acquisition unit (42) that acquires a travel trajectory (Tr) of the own vehicle; an own vehicle direction acquisition unit (43) that acquires an own vehicle direction (Ds) that is a direction in which the own vehicle is facing on the travel trajectory; a target travelling direction acquisition unit (46) that acquires a target travelling direction (Dt) that is a travelling direction of another vehicle (Vt) serving as the object present behind the own vehicle; and a notification subject determination unit (47) that determines whether the other vehicle is a notification subject based on the own vehicle direction and the target travelling direction.

### Second Aspect

The driving assistance apparatus according to the first aspect, in which: the own vehicle direction acquisition unit acquires the own vehicle direction at a closest point (Pn) that is a point on the travel trajectory closest to a reference point (Pr) on the other vehicle; the notification subject determination unit excludes the other vehicle from the notification subject when an exclusion condition is met; and the exclusion condition includes an angle formed by the own vehicle direction and the target travelling direction being equal to or greater than a threshold.

### Third Aspect

The driving assistance apparatus according to the first aspect, in which: the own vehicle direction acquisition unit acquires the own vehicle direction at a turning start point (Pc) at which turning behavior of the own vehicle starts; the notification subject determination unit excludes the other vehicle from the notification subject when an exclusion condition is met; and the exclusion condition includes an angle formed by the own vehicle direction and the target travelling direction being equal to or less than a threshold.

### Fourth Aspect

The driving assistance apparatus according to the first aspect, in which: the own vehicle direction acquisition unit acquires an own vehicle first direction that is the own vehicle direction at a closest point that is a point on the travel trajectory closest to a reference point (Pr) on the other vehicle and an own vehicle second direction that is the own vehicle direction at a turning start point (Pc) at which turning behavior of the own vehicle starts; the notification subject determining means excludes the other vehicle from the notification subject when an exclusion condition is met; the exclusion condition includes an angle formed by the own vehicle first direction and the target travelling direction being equal to or greater than a first threshold and an angle formed by the own vehicle second direction and the target travelling direction being equal to or less than a second threshold.

### Fifth Aspect

The driving assistance apparatus according to any one of the second to fourth aspects, in which: the exclusion condition includes either or both of a current time being within a predetermined amount of time from completion of turn behavior of the own vehicle and the other vehicle being within a predetermined distance range behind the own vehicle.

### Sixth Aspect

A driving assistance method by which, based on detection information of an object in a vicinity of an own vehicle (Vs), an occupant of the own vehicle is notified that the own vehicle and the object are approaching each other, the driving assistance method including:
acquiring a travel trajectory (Tr) of the own vehicle; acquiring an own vehicle direction (Ds) that is a direction in which the own vehicle is facing on the travel trajectory; acquiring a target travelling direction (Dt) that is a travelling direction of another vehicle (Vt) serving as the object present behind the own vehicle; and determining whether the other vehicle is a notification subject based on the own vehicle direction and the target travelling direction.

### Seventh Aspect

The driving assistance method according to the sixth aspect, in which: the acquisition of the own vehicle direction is acquiring the own vehicle direction at a closest point (Pn) that is a point on the travel trajectory closest to a reference point (Pr) on the other vehicle; the determination of whether the other vehicle is a notification subject excludes the other vehicle from the notification subject when an exclusion condition is met; and the exclusion condition includes an angle formed by the own vehicle direction and the target travelling direction being equal to or greater than a threshold.

### Eighth Aspect

The driving assistance method according to the sixth aspect, in which: the acquisition of the own vehicle direction is acquiring the own vehicle direction at a turning start point (Pc) at which turning behavior of the own vehicle starts; the determination of whether the other vehicle is a notification subject excludes the other vehicle from the notification subject when an exclusion condition is met; and the exclusion condition includes an angle formed by the own vehicle direction and the target travelling direction being equal to or less than a threshold.

### Ninth Aspect

The driving assistance method according to the sixth aspect, in which: the acquisition of the own vehicle direction is acquiring an own vehicle first direction that is the own vehicle direction at a closest point that is a point on the travel trajectory closest to a reference point (Pr) on the other vehicle and an own vehicle second direction that is the own vehicle direction at a turning start point (Pc) at which turning behavior of the own vehicle starts; the determination of whether the other vehicle is a notification subject excludes the other vehicle from the notification subject when an exclusion condition is met; and the exclusion condition includes an angle formed by the own vehicle first direction and the target travelling direction being equal to or greater than a first threshold and an angle formed by the own vehicle second direction and the target travelling direction being equal to or less than a second threshold.

### Tenth Aspect

The driving assistance method according to any one of the seventh to ninth aspects, in which: the exclusion condition includes either or both of a current time being within a predetermined amount of time from completion of turn behavior of the own vehicle and the other vehicle being within a predetermined distance range behind the own vehicle.

### Eleventh Aspect

A non-transitory computer-readable storage medium storing therein a driving assistance program executed by a driving assistance apparatus (4) that is configured to, based on detection information of an object in a vicinity of an own vehicle (Vs), notify an occupant of the own vehicle that the own vehicle and the object are approaching each other, the driving assistance program including processes including: a process for acquiring a travel trajectory (Tr) of the own vehicle; a process for acquiring an own vehicle direction (Ds) that is a direction in which the own vehicle is facing on the travel trajectory; a process for acquiring a target travelling direction (Dt) that is a travelling direction of another vehicle (Vt) serving as the object present behind the own vehicle; and a process for determining whether the other vehicle is a notification subject based on the own vehicle direction and the target travelling direction.

### Twelfth Aspect

The storage medium according to the eleventh aspect, in which: the process for acquiring the own vehicle direction acquires the own vehicle direction at a closest point (Pn) that is a point on the travel trajectory closest to a reference point (Pr) on the other vehicle; the process for determining whether the other vehicle is a notification subject excludes the other vehicle from the notification subject when an exclusion condition is met; and the exclusion condition includes an angle formed by the own vehicle direction and the target travelling direction being equal to or greater than a threshold.

### Thirteenth Aspect

The storage medium according to the eleventh aspect, in which: the process for acquiring the own vehicle direction acquires the own vehicle direction at a turning start point (Pc) at which turning behavior of the own vehicle starts; the process for determining whether the other vehicle is a notification subject excludes the other vehicle from the notification subject when an exclusion condition is met; and the exclusion condition includes an angle formed by the own vehicle direction and the target travelling direction being equal to or less than a threshold.

### Fourteenth Aspect

The storage medium according to the eleventh aspect, in which: the process for acquiring the own vehicle direction acquires an own vehicle first direction that is the own vehicle direction at a closest point that is a point on the travel trajectory closest to a reference point (Pr) on the other vehicle and an own vehicle second direction that is the own vehicle direction at a turning start point (Pc) at which turning behavior of the own vehicle starts; the process for determining whether the other vehicle is a notification subject excludes the other vehicle from the notification subject when an exclusion condition is met; and the exclusion condition includes an angle formed by the own vehicle first direction and the target travelling direction being equal to or greater than a first threshold and an angle formed by the own vehicle second direction and the target travelling direction being equal to or less than a second threshold.

### Fifteenth Aspect

The storage medium according to the twelfth to fourteenth aspects, in which: the exclusion condition includes either or both of a current time being within a predetermined amount of time from completion of turn behavior of the own vehicle and the other vehicle being within a predetermined distance range behind the own vehicle.

What is claimed is:

1. A driving assistance apparatus that is configured to, based on detection information of an object in a vicinity of an own vehicle, notify an occupant of the own vehicle that the own vehicle and the object are approaching each other, the driving assistance apparatus comprising:
at least one of (i) a circuit and (ii) a processor with a memory storing computer program code executable by the processor, the at least one of the circuit and the processor configured to implement:
a travel trajectory acquisition unit that acquires a travel trajectory of the own vehicle;
an own vehicle direction acquisition unit that acquires an own vehicle direction that is a direction in which the own vehicle is facing on the travel trajectory;
a target travelling direction acquisition unit that acquires a target travelling direction that is a travelling direction of another vehicle serving as the object present behind the own vehicle; and
a notification subject determination unit that determines whether the other vehicle is a notification subject based on the own vehicle direction and the target travelling direction.

2. The driving assistance apparatus according to claim 1, wherein:
the own vehicle direction acquisition unit acquires the own vehicle direction at a closest point that is a point on the travel trajectory closest to a reference point on the other vehicle;
the notification subject determination unit excludes the other vehicle from the notification subject when an exclusion condition is met; and
the exclusion condition includes an angle formed by the own vehicle direction and the target travelling direction being equal to or greater than a threshold.

3. The driving assistance apparatus according to claim 1, wherein:
the own vehicle direction acquisition unit acquires the own vehicle direction at a turning start point at which turning behavior of the own vehicle starts;
the notification subject determination unit excludes the other vehicle from the notification subject when an exclusion condition is met; and
the exclusion condition includes an angle formed by the own vehicle direction and the target travelling direction being equal to or less than a threshold.

4. The driving assistance apparatus according to claim 1, wherein:
the own vehicle direction acquisition unit acquires an own vehicle first direction that is the own vehicle direction at a closest point that is a point on the travel trajectory closest to a reference point on the other vehicle and an own vehicle second direction that is the own vehicle direction at a turning start point at which turning behavior of the own vehicle starts;
the notification subject determining means excludes the other vehicle from the notification subject when an exclusion condition is met;
the exclusion condition includes
an angle formed by the own vehicle first direction and the target travelling direction being equal to or greater than a first threshold and
an angle formed by the own vehicle second direction and the target travelling direction being equal to or less than a second threshold.

5. The driving assistance apparatus according to claim 2, wherein:
the exclusion condition includes either or both of
a current time being within a predetermined amount of time from completion of turn behavior of the own vehicle and
the other vehicle being within a predetermined distance range behind the own vehicle.

6. A driving assistance method by which, based on detection information of an object in a vicinity of an own vehicle, an occupant of the own vehicle is notified that the own vehicle and the object are approaching each other, the driving assistance method comprising:
acquiring a travel trajectory of the own vehicle;
acquiring an own vehicle direction that is a direction in which the own vehicle is facing on the travel trajectory;
acquiring a target travelling direction that is a travelling direction of another vehicle serving as the object present behind the own vehicle; and
determining whether the other vehicle is a notification subject based on the own vehicle direction and the target travelling direction.

7. The driving assistance method according to claim 6, wherein:
the acquisition of the own vehicle direction is acquiring the own vehicle direction at a closest point that is a point on the travel trajectory closest to a reference point on the other vehicle;
the determination of whether the other vehicle is a notification subject excludes the other vehicle from the notification subject when an exclusion condition is met; and
the exclusion condition includes an angle formed by the own vehicle direction and the target travelling direction being equal to or greater than a threshold.

8. The driving assistance method according to claim 6, wherein:
the acquisition of the own vehicle direction is acquiring the own vehicle direction at a turning start point at which turning behavior of the own vehicle starts;
the determination of whether the other vehicle is a notification subject excludes the other vehicle from the notification subject when an exclusion condition is met; and
the exclusion condition includes an angle formed by the own vehicle direction and the target travelling direction being equal to or less than a threshold.

9. The driving assistance method according to claim 6, wherein:
the acquisition of the own vehicle direction is acquiring an own vehicle first direction that is the own vehicle direction at a closest point that is a point on the travel trajectory closest to a reference point on the other vehicle and an own vehicle second direction that is the own vehicle direction at a turning start point at which turning behavior of the own vehicle starts;
the determination of whether the other vehicle is a notification subject excludes the other vehicle from the notification subject when an exclusion condition is met; and
the exclusion condition includes
an angle formed by the own vehicle first direction and the target travelling direction being equal to or greater than a first threshold and
an angle formed by the own vehicle second direction and the target travelling direction being equal to or less than a second threshold.

10. The driving assistance method according to claim 7, wherein:
the exclusion condition includes either or both of
a current time being within a predetermined amount of time from completion of turn behavior of the own vehicle and
the other vehicle being within a predetermined distance range behind the own vehicle.

11. A non-transitory computer-readable storage medium storing therein a driving assistance program executed by a driving assistance apparatus that is configured to, based on detection information of an object in a vicinity of an own vehicle, notify an occupant of the own vehicle that the own vehicle and the object are approaching each other, the driving assistance program including processes comprising:
a process for acquiring a travel trajectory of the own vehicle;
a process for acquiring an own vehicle direction that is a direction in which the own vehicle is facing on the travel trajectory;
a process for acquiring a target travelling direction that is a travelling direction of another vehicle serving as the object present behind the own vehicle; and
a process for determining whether the other vehicle is a notification subject based on the own vehicle direction and the target travelling direction.

12. The storage medium according to claim 11, wherein:
the process for acquiring the own vehicle direction acquires the own vehicle direction at a closest point that is a point on the travel trajectory closest to a reference point on the other vehicle;
the process for determining whether the other vehicle is a notification subject excludes the other vehicle from the notification subject when an exclusion condition is met; and
the exclusion condition includes an angle formed by the own vehicle direction and the target travelling direction being equal to or greater than a threshold.

13. The storage medium according to claim 11, wherein:
the process for acquiring the own vehicle direction acquires the own vehicle direction at a turning start point at which turning behavior of the own vehicle starts;
the process for determining whether the other vehicle is a notification subject excludes the other vehicle from the notification subject when an exclusion condition is met; and
the exclusion condition includes an angle formed by the own vehicle direction and the target travelling direction being equal to or less than a threshold.

14. The storage medium according to claim 11, wherein:
the process for acquiring the own vehicle direction acquires an own vehicle first direction that is the own vehicle direction at a closest point that is a point on the travel trajectory closest to a reference point on the other vehicle and an own vehicle second direction that is the own vehicle direction at a turning start point at which turning behavior of the own vehicle starts;
the process for determining whether the other vehicle is a notification subject excludes the other vehicle from the notification subject when an exclusion condition is met; and
the exclusion condition includes
an angle formed by the own vehicle first direction and the target travelling direction being equal to or greater than a first threshold and
an angle formed by the own vehicle second direction and the target travelling direction being equal to or less than a second threshold.

15. The storage medium according to claim 12, wherein:
the exclusion condition includes either or both of
a current time being within a predetermined amount of time from completion of turn behavior of the own vehicle and
the other vehicle being within a predetermined distance range behind the own vehicle.
